(19) United States
(12) Patent Application Publication
(10) Pub. No.: US 2021/0310357 A1
(43) Pub. Date: Oct. 7, 2021

(54) Thrust Vectoring Ignition Chamber Engine with Axial Fuel Intake System

(71) Applicant: Ravi Shankar Gautam, Gaya (IN)

(72) Inventor: Ravi Shankar Gautam, Gaya (IN)

(21) Appl. No.: 17/262,758

(22) PCT Filed: Jul. 25, 2019
(86) PCT No.: PCT/IN2019/050541

§ 371 Date: Jan. 25, 2021

(30) Foreign Application Priority Data
Jul. 25, 2018 (IN) 201821027864

(51) Int. Cl. F01B 3/04; F02M 57/06; F02B 75/26; F01B 9/06

(52) U.S. Cl. CPC F01B 3/04; F01B 9/06; F02B 75/26; F02M 57/06

(57) ABSTRACT

This patent discloses thrust vectoring ignition chamber engine. Thrust vectoring ignition chamber used in this engine is an annular cylinder having nozzles mounted in a way such that during fuel suction phase they are sealed and during ignition of fuel they are unsealed so that hot jets of ignited fuel escaping through nozzles cause coupled rotatory motion on the ignition chamber. Engine uses specially designed dwell barrel cam mechanism for suction and compression of fuel. Flywheel mounted on extension of ignition chamber functions as output of the engine. Each half rotation of flywheel completes three phases namely fuel/air suction, compression and combustion. Thus this engine fires for every half revolution and therefore can give improved power boost.

### FIELD OF INVENTION

The present disclosure relates generally to engine which can use petrol, diesel, compressed natural gas etc as fuel.

### BACKGROUND OF INVENTION

Automobiles have played significant role in enhancing human civilization by transporting agricultural products, construction material to build better homes etc. In automobile engines we need output which can rotate wheels. All automobile engines consist of cylindrical ignition chamber in which a piston is slip fit and is allowed to move back and forth at cylinder's rear end. Fuel-air mixture that ignition chamber received from an inlet valve (located at front end) is compressed and ignited to cause sudden expansion of gas which in turn causes thrust to the piston forcing in move rearwards. Connecting rods connecting the piston to crank shaft helps to convert translation motion of piston to rotatory motion of crankshaft which in turn causes flywheel (that is axially attached to crankshaft) to rotate. Flywheel causes wheel of automobile to rotate via transmission mechanism. One cycle of a four stroke engine for generating thrust from fuel consists of four phases namely fuel-air mixture suction, fuel-air mixture compression, ignition via spark plug (that causes thrust) and exhaust of burnt gas through exhaust valve located on the front end of ignition chamber. Each phase requires one strokes of piston and hence one cycle involves two rotations of crankshaft and therefore flywheel.

Around two centuries prior to the invention of modern day internal combustion chamber engine described above, two inventors Marcus Vitruvius Pollio (c. 80 BCE-c. 15 CE) from Rome and Hero (c. 10-70 CE) from Alexandria (Greece) had independently conceived of a steam engine named Aeolipile which was based on principle of thrust vectoring of steam enclosed in a chamber through transversely oriented nozzles. Automobile engine according to this invention is based on thrust vectoring concept which can also be seen in action in garden sprinkler, Catherine wheel, fighter jets etc.

### TECHNICAL PROBLEM

One of the drawbacks of four stroke engine is one phase of exhaust of burnt fuel gas is unproductive.

One of the drawbacks of four stroke engine is that it requires conversion of translation motion to rotatory motion for compression of fuel-air mixture as well as rotation of crankshaft.

One of the drawbacks of four stroke engine is that moving parts like exhaust valve comes in contact with ignited fuel gas mixture due to which it requires overhaul and maintenance. For example unmaintained exhaust valves may cause fuel backfire.

One of the drawbacks of four stroke engine is that it requires complex process and lot of moving parts to operate cam mechanisms for operating inlet and exhaust valves.

One of the drawbacks of two stroke engine is that exhaust gas and fuel gets mixed which causes lot of pollution.

### SUMMARY OF INVENTION

One of the objectives is to provide an engine which can directly convert fuel thrust to rotatory motion. This is achieved by thrust vectored exit of ignited fuel-air mixture. Ignited fuel-air mixture is bound to escape through pair of angled nozzles located at diametrically opposite sides of ignition chamber. Nozzles are angled with each nozzle making an acute angle with respect to outward radial direction. Difference between angles that nozzles make with the line joining them is 180 degree so that the exhaust of gas cause coupled torque on the ignition chamber.

In the engine, according to this invention, piston based compression mechanism have been retained to achieve high compression.

In the engine, according to this invention, each half rotation of flywheel completes three phases namely fuel/air suction, compression and combustion, instead of two rotations as required in engine according to prior art. Thus this engine improves power boost.

Engine, according to this invention, do not require a separate phase for exhaust of burnt gas and do not cause mixing of exhaust gas with fuel as well.

In the engine, according to this invention, ignition chamber directly operates the cam mechanism without involving large number of moving parts.

In the engine, according to this invention, involves a novel method to securely operate dwell barrel cam mechanism for suction and compression of fuel using sleeve gear.

### BRIEF DESCRIPTION OF DRAWINGS

FIG. 1 and FIG. 2 Front and rear view of barrel cam based thrust vectoring ignition chamber engine according to this invention

FIG. 3 and FIG. 4 Front and side view of outer barrel cam cylinder illustrating two coaxially parallel dwell barrel cam grooves.

FIG. 5 Rear view of outer and inner barrel cam cylinder illustrating two coaxially parallel dwell barrel cam grooves.

FIG. 6 and FIG. 7 Front and rear view of outer and inner barrel cam follower cylinder illustrating linear grooves.

FIG. 8 Rear view of barrel cam support mechanism illustrating outer sleeve gear, inner sleeve gear and sleeve gear connector.

FIG. 9 Front view of outer sleeve gear

FIG. 10 Front view of inner sleeve gear and sleeve gear connector

FIG. 11 and FIG. 12 Front and side view of fuel supply and ignition mechanism illustrating cylindrical cam based fuel valve control mechanism.

FIG. 13 and FIG. 14 Nozzle as pair of straight tubes and curved tubes respectively.

### DESCRIPTION OF EMBODIMENTS

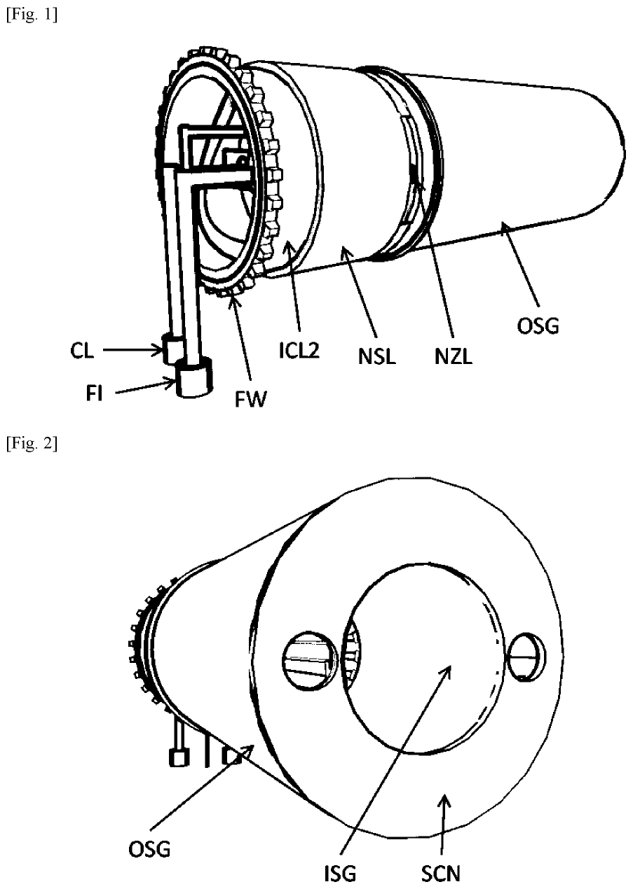

Referring to [FIG. 1], the preferred embodiment of an automobile engine (1) according to this invention is shown to include an engine enclosure (ENC), thrust vectoring ignition chamber (IC), fuel suction and compression system (FSC), fuel delivery and ignition mechanism (FDI), nozzle seal (NSL), and flywheel (FW).

Engine enclosure (ENC) appropriately secures all parts of engine, provides support to engine via rectangular slabs attached to outer static parts of engine like nozzle seal and outer sleeve gear of fuel suction and compression system and provides exit to the burnt fuel gas via exhaust pipe.

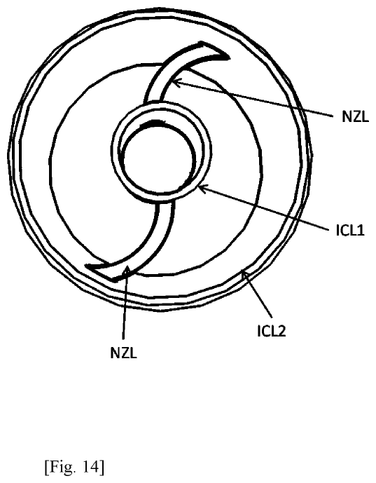

Thrust vectoring ignition chamber (IC), as shown in [FIG. 12], consists of a pair of coaxial annular cylinders, an inner annular cylinder (ICL1) and an outer annular cylinder (ICL2), connected coaxially via coaxial rings (IR), and coupled thrust vectoring nozzle (NZL) wherein
inner annular cylinder (ICL1) is coaxially caped at front side by ignition chamber seal (ICS), which is a circular disk, via coaxial ball bearing;
fuel suction and compression system (FSC) and fuel delivery and ignition mechanism (FDI) on on rear and front side, respectively of the ignition chamber;
coupled thrust vectoring nozzle (NZL), as shown in [FIG. 13], is a pair of conical tubes mounted at diametrically opposite points on the right circular section on the middle part of ignition chamber by passing through holes on the inner annular cylinder (ICL1) and outer annular cylinder (ICL2) such that one end with bigger aperture opens inside the inner annular cylinder (ICL1) and other end with smaller aperture opens on the outer side of outer annular cylinder (ICL2);
each tube make equal acute angle with respect to radially outward direction in opposite direction along the right circular section of ignition chamber;
surface of the nozzles on the outer side of ignition chamber are cut to take the shape of outer surface of the outer annular cylinder (ICL2) so that ignition chamber can glide inside the nozzle seal cylinder smoothly and surface of the nozzles on the inner side of ignition chamber are cut to take the shape of inner surface of the inner annular cylinder (ICL1);
ignition chamber (IC) extends towards front side of the nozzle wherein its outer annular cylinder (ICL2) extends longer than the inner annular cylinder (ICL1) towards the front side.

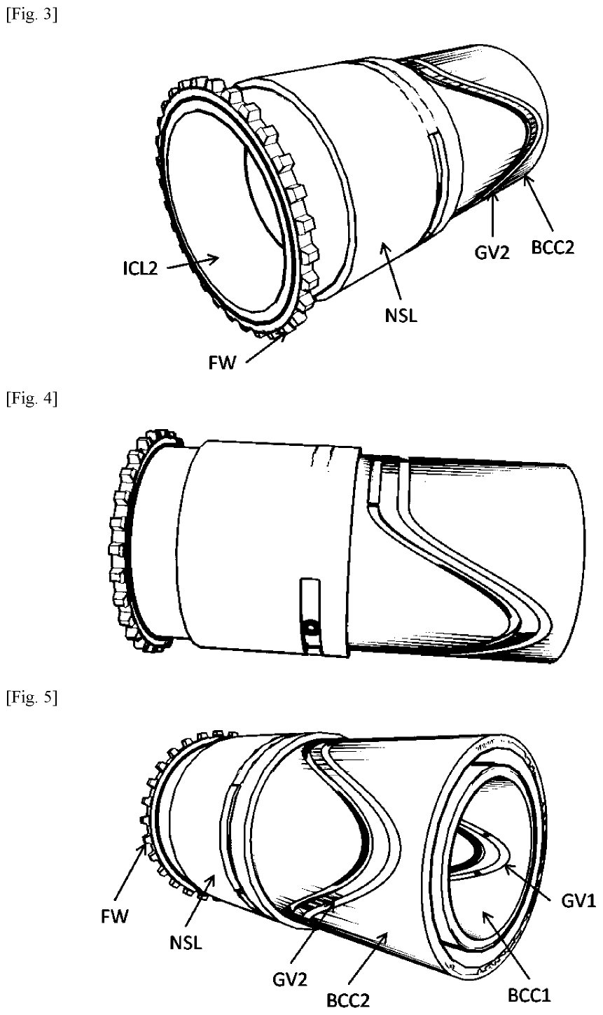

Nozzle seal (NSL), used to seal and unseal nozzle (NZL), as shown in [FIG. 3], [FIG. 4] and [FIG. 5], is an annular cylinder which holds outer annular cylinder (ICL2) of the ignition chamber via ball bearing such that
its middle portion falls above the nozzle (NZL);
its length is such that outer annular cylinder (ICL2) is exposed on its rear and front side;
its middle portion has two rectangular holes at diametrically opposite sides, with length of each hole is such that they subtend an angle of 60 degree (may be calibrated according to the requirement) at the center of the circle and width little greater than the diameter of the outer aperture of nozzles;
thrust vectoring nozzle (NZL) remain sealed except when passes under gas exiting holes of nozzle seal (NSL).

Fuel suction and compression system (FSC), which is designed to suck fuel-air mixture inside the ignition chamber and then compress it, consists of inner barrel cam mechanism (IBC) and outer barrel cam mechanism (OBC), barrel cam connector (BCN), barrel cam support mechanism (BCS).

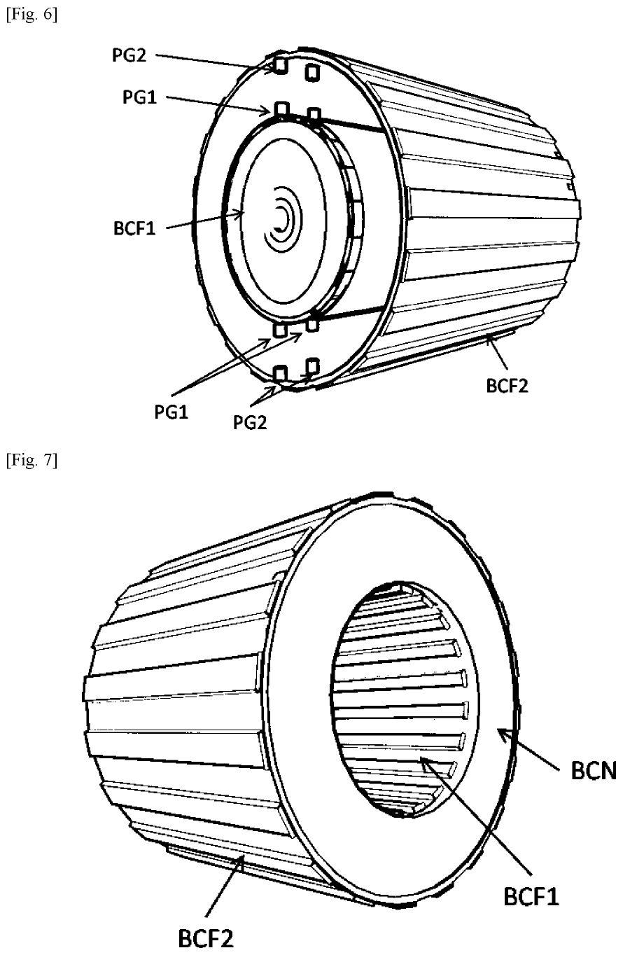

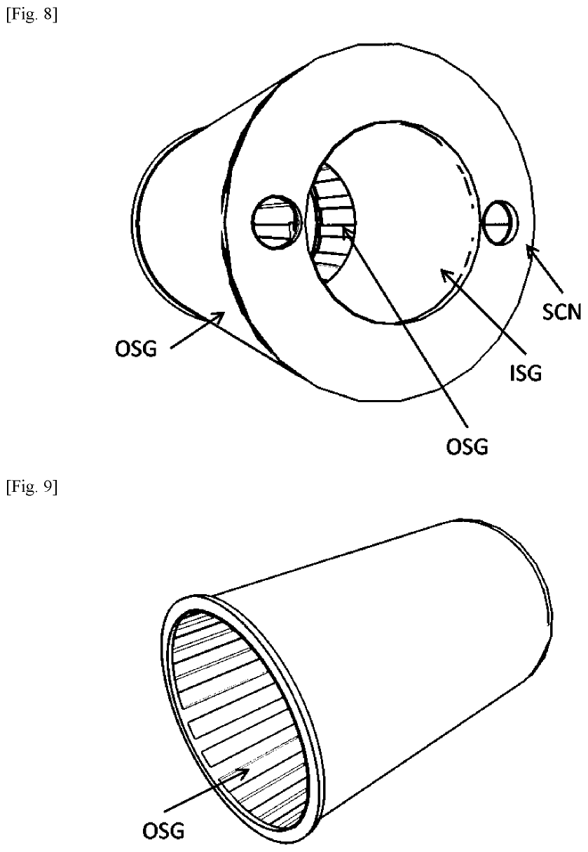

Inner barrel cam mechanism (IBC), consists of inner barrel cam cylinder (BCC1), inner barrel cam follower (BCF1) wherein
inner barrel cam cylinder (BCC1), as shown in [FIG. 5], an annular cylinder with inner and outer radius equal to that of inner cylinder of ignition chamber, is coaxially attached to it as latter's extension and has two coaxially parallel dwell cam grooves (GV1) with each groove having two peaks, two troughs and two dwells with each dwell extending a trough point into a groove of shape of a circular arc;
inner barrel cam follower (BCF1), as shown in [FIG. 6] and [FIG. 7], an annular cylinder having outer radius equal to the inner radius of inner barrel cam cylinder (BCC1), having two pair of pegs (PG1) with one pair located at diametrically opposite side to that of the other, is slip fit into inner barrel cam cylinder (BCC1) such that front and rear peg of each pair falls in the front cam groove and rear cam groove respectively;

Outer barrel cam mechanism (OBC) consists of outer barrel cam cylinder (BCC2), outer barrel cam follower (BCF2) wherein
outer barrel cam cylinder (BCC2), as shown in [FIG. 4] and [FIG. 5], an annular cylinder with inner and outer radius equal to that of outer cylinder of ignition chamber, is coaxially attached to it as latter's extension and has two coaxially parallel dwell cam grooves (GV2) with each groove having two peaks, two troughs and two dwells with each dwell extending a trough point into a groove of shape of a circular arc;
outer barrel cam follower (BCF2) as shown in [FIG. 6] and [FIG. 7], an annular cylinder, with an inner radius equal to the outer radius of outer barrel cam cylinder (BCC2), having two pair of pegs (PG2) attached at former's inner surface, with one pair located at diametrically opposite side to that of the other, is slip fit into outer barrel cam cylinder (BCC2) such that front and rear peg of each pair falls in the front cam groove and rear cam groove respectively;
additionally outer barrel cam follower (BCF2), as shown in [FIG. 6] and [FIG. 7], has a longitudinal teeth on its outer surface so that it can be meshingly engaged with sleeve gear of barrel cam support mechanism, as its hub gear;
inner side of outer barrel cam follower (BCF2), as shown in [FIG. 7], at its rear end is coaxially connected via Barrel cam connector (BCN), a coaxial annular circular disk, to the outer side of inner barrel cam follower (BCF1) at latter's rear end.

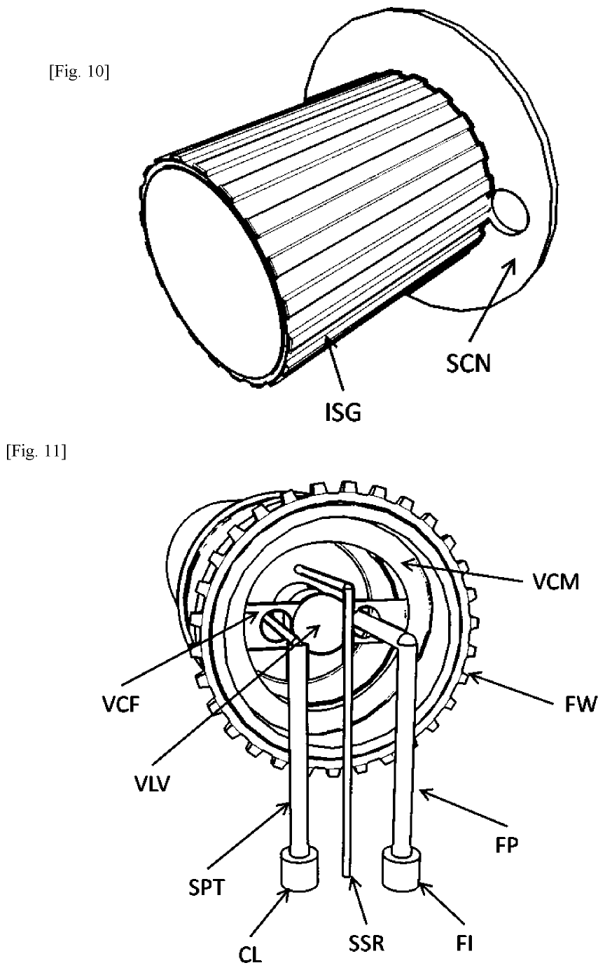

Barrel cam support mechanism (BCS), as shown in [FIG. 8], [FIG. 9] and [FIG. 10], consists of a outer sleeve gear (OSG), inner sleeve gear (ISG), sleeve gear connector (SCN), a pair of rectangular slabs (SLB2) and (SLB3), of engine securing mechanism (ESM) wherein
outer sleeve gear (OSG), is a sleeve gear with internal teeth, of length greater than double the length of outer barrel cam follower (BCF2), is mounted coaxially on latter's outer side with its front end coaxially attached to the rear end of nozzle seal cylinder (NSL);
longitudinal teeth on the inner surface of outer sleeve gear (OSG) meshingly engages with longitudinal teeth of outer surface of outer barrel cam follower (BCF2);
inner sleeve gear (ISG), is a sleeve gear with external teeth, of length equal to the length of inner barrel cam follower (BCF1), and outer radius equal to the inner radius of the inner barrel cam follower with its rear end coaxially attached to the rear end of outer sleeve gear via a sleeve gear connector (SCN) a circular annular plate;
longitudinal teeth on the outer surface of inner sleeve gear (ISG) meshingly engages with longitudinal teeth of inner surface of inner barrel cam follower (BCF1).

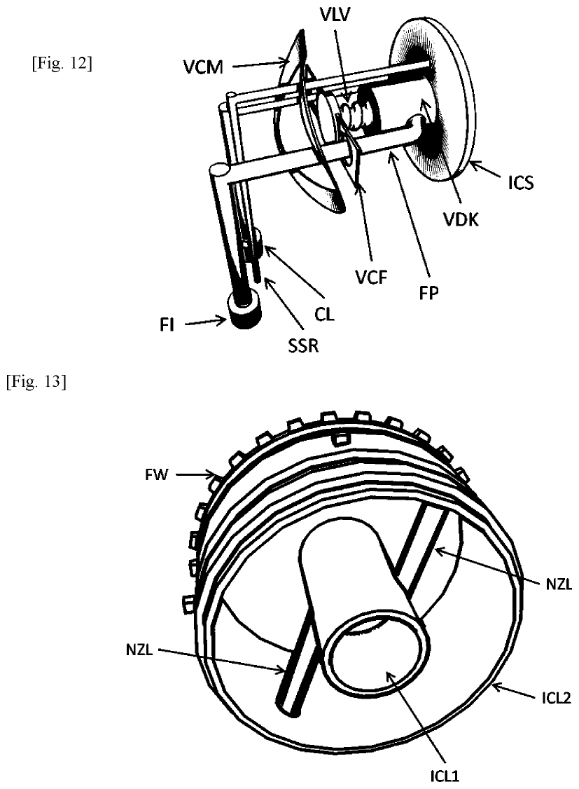

Fuel delivery and ignition mechanism, as shown in [FIG. 11] and [FIG. 12], consists of ignition chamber seal (ICS), spark plug (SP), ignition coil (CL), air-fuel valve (VLV), fuel pipe (FP), fuel injector (FI) wherein
ignition chamber seal (ICS), a circular disk attached with valve deck (VDK), spark plug deck (SDK) and seal support rod (SSR) caps the inner annular cylinder (ICL1) of ignition chamber so that nozzle falls close to its rear side;
valve deck (VDK), an horizontal annular cylindrical, is sealingly attached at its rear end to a hole at the center of front side of ignition chamber seal and opening on former's rear side towards the nozzle of the ignition chamber;
spark plug deck (SDK), a horizontal narrow annular cylindrical which at its rear end houses spark plug such that latter's electrode lies inside ignition chamber facing towards the nozzle and front part leads to ignition coil, is located on right side of and parallel to valve deck;
seal support rod (SSR), a L-shaped rod, whose horizontal arm is located on lower side of and parallel to valve deck (VDK) and is attached at its rear end to the front side of ignition chamber seal (ICS) and vertical arm is attached to engine enclosure;
air-fuel valve (VLV), is housed in valve deck so that it opens inside the ignition chamber towards the nozzle and spring retainer attached with air-fuel valve cam follower (VCF), is exposed outside the valve deck and is operated by air-fuel valve cam (VCM);
air-fuel valve cam (VCM), is a cylindrical cam located on the inner side of the exposed portion of the outer cylinder near to spring retainer of air-fuel valve (VLV);
air-fuel pipe (FP), a L-shaped pipe, with its horizontal arm parallel to valve deck bent appropriately, to pass through into valve deck and vertical arm extends downward to lead to fuel injector (FI) outside of outer cylinder of ignition chamber.;
air-fuel valve cam follower (VCF), a pair of small rectangular plates, attached at diametrically opposite ends of spring retainer extending radially towards air-fuel valve cam (VCM), wherein each of rectangular plates has a hole through which horizontal arm of spark fuel deck (SDK) and air-fuel pipe (FP) pass through.

Flywheel (FW), as shown in [FIG. 1], an externally teethed annular gear that functions as an output of the engine, is connected coaxially to the front side extension of outer annular cylinder (ICL2) of ignition chamber.

Thrust vectored ignition chamber engine described above is an engine which can use petrol as fuel and in order to use diesel as a fuel we need to replace spark plug with pressure valve, ignition coil with fuel source, air-fuel valve with air valve.

According to another variation to above description, thrust vectoring nozzle (NZL), as shown in [FIG. 14], consists of pair of curved conical tubes so that escape angle of gas at outer surface of outer cylinder (ICL2) of ignition chamber can be closer to tangent of circle described by nozzles with aperture of nozzles inside the inner cylinder (ICL1) of ignition chamber, is along radial direction.

### Engine Operation for Stationary Nozzle Seal

Each half rotation of ignition chamber and therefore flywheel is completes a cycle of three phases namely suction phase, compression phase and combustion phase occurring in serial order.

In suction phase nozzles are in closed state, fuel valve is in open state, and barrel cam follower pin is moving from trough to peak of the cam groove forcing barrel cam follower to move away from the nozzle while sucking the air-fuel mixture into the ignition chamber. In compression phase nozzles are in closed state, fuel valve is in closed state and barrel cam follower pin is moving from peak to trough of the cam groove forcing barrel cam follower to move towards the nozzle while compressing the air-fuel mixture in the ignition chamber. In combustion phase nozzles are in open state, fuel valve is in closed state and barrel cam follower pin is moving dwell part of the cam groove forcing barrel cam follower to stay at the dead end.

During combustion phase nozzles of the ignition chamber are in open state and compressed air-fuel mixture is ignited due to which hot air gushes out of the nozzles to cause coupling torque action resulting in rotatory thrust on the ignition chamber. As soon as half rotation is complete the nozzles come in closed state. A separate phase to expell burnt gas is not required.

During suction phase air-fuel valve is opened by pressing action of cam follower attached to spring retainer by the cylindrical cam. During suction and compression phase inner and outer sleeve gears provides support as well as constraints the inner and outer barrel cam followers to move only in longitudinal direction.

Following are my claims in this Letter of Patent:

1. An automobile engine, for directly converting the fuel energy to rotatory motion using thrust vectoring of ignited fuel, consisting of an engine enclosure, thrust vectoring ignition chamber, fuel suction and compression system, fuel delivery and ignition mechanism, nozzle seal and flywheel.

2. Engine enclosure, claimed in claim [1], appropriately secures all parts of engine, provides support to engine via rectangular slabs attached to outer static parts of engine like nozzle seal and outer sleeve gear of fuel suction and compression system, claimed in claim [1], and provides exit to the burnt fuel gas via exhaust pipe.

3. Thrust vectoring ignition chamber, claimed in claim [1], consists of a pair of coaxial annular cylinders, an inner annular cylinder and an outer annular cylinder, connected coaxially via coaxial rings, and coupled thrust vectoring nozzle wherein
inner annular cylinder is coaxially caped at its front side by ignition chamber seal, which is a circular disk, via coaxial ball bearing;
fuel suction and compression system and fuel delivery and ignition mechanism is mounted on rear and front side, respectively of the ignition chamber;
coupled thrust vectoring nozzle is a pair of conical tubes mounted at diametrically opposite points on the right circular section on the middle part of ignition chamber by passing through holes on the inner annular cylinder and outer annular cylinder such that one end with bigger aperture opens inside the inner annular cylinder and other end with smaller aperture opens on the outer side of outer annular cylinder;
each tube make equal acute angle with respect to radially outward direction in opposite direction along the right circular section in middle portion of ignition chamber;
surface of the nozzles on the outer side of ignition chamber are cut to take the shape of outer surface of the outer cylinder so that ignition chamber can glide inside the nozzle seal cylinder smoothly and surface of the nozzles on the inner side of ignition chamber are cut to take the shape of inner surface of the inner annular cylinder;
ignition chamber extends towards front side of the nozzle wherein its outer annular cylinder extends longer than the inner annular cylinder towards the front side.

4. Nozzle seal, claimed in claim [1], which functions to seal and unseal nozzle, is a static annular cylinder which holds outer annular cylinder of the ignition chamber via ball bearing such that its middle portion falls above the nozzle;
its length is such that outer annular cylinder is exposed on its rear and front side;
its middle portion has two rectangular holes at diametrically opposite sides, with length of each hole is such that they subtend an angle of 60 degree (may be calibrated according to the requirement) at the center of the circle and width little greater than the diameter of the outer aperture of nozzles;
thrust vectoring nozzle remain sealed except when passes under gas exiting holes on the nozzle seal.

5. Fuel suction and compression system, claimed in claim [1], designed to suck fuel-air mixture inside the ignition chamber and then compress it, consists of inner barrel cam mechanism and outer barrel cam mechanism, barrel cam connector, barrel cam support mechanism.

6. Inner barrel cam mechanism, mentioned in claim [5], consists of inner barrel cam cylinder, inner barrel cam follower wherein
inner barrel cam cylinder, an annular cylinder with inner and outer radius equal to that of inner cylinder of ignition chamber, is coaxially attached to it as latter's extension and has two coaxially parallel dwell cam grooves with each groove having two peaks, two troughs and two dwells with each dwell extending a trough point into a groove of shape of a circular arc;
inner barrel cam follower an annular cylinder having outer radius equal to the inner radius of inner barrel cam cylinder, having two pair of pegs with one pair located at diametrically opposite side to that of the other, is slip fit into inner barrel cam cylinder such that front and rear peg of each pair falls in the front cam groove and rear cam groove respectively;

7. Outer barrel cam mechanism, claimed in claim [5], consists of outer barrel cam cylinder, outer barrel cam follower wherein
outer barrel cam cylinder, an annular cylinder with inner and outer radius equal to that of outer cylinder of ignition chamber, is coaxially attached to it as latter's extension and has two coaxially parallel dwell cam grooves with each groove having two peaks, two troughs and two dwells with each dwell extending a trough point into a groove of shape of a circular arc;
outer barrel cam follower, an annular cylinder with an inner radius equal to the outer radius of outer barrel cam cylinder, having two pair of pegs attached at former's inner surface, with one pair located at diametrically opposite side to that of the other, is slip fit into outer barrel cam cylinder such that front and rear peg of each pair falls in the front cam groove and rear cam groove respectively;
additionally outer barrel cam follower, has a longitudinal teeth on its outer surface so that it can be meshingly engaged with sleeve gear of barrel cam support mechanism, as its hub gear;
inner side of outer barrel cam follower at its rear end is coaxially connected via Barrel cam connector, a coaxial annular circular disk, to the outer side of inner barrel cam follower at latter's rear end.

8. Barrel cam support mechanism, claimed in claim [5], consists of a outer sleeve gear, inner sleeve gear, sleeve gear connector, a pair of rectangular slabs, of engine securing mechanism wherein
outer sleeve gear, is a sleeve gear with internal teeth, of length greater than double the length of outer barrel cam follower, is mounted coaxially on latter's outer side with its front end coaxially attached to the rear end of nozzle seal cylinder;
longitudinal teeth on the inner surface of outer sleeve gear meshingly engages with longitudinal teeth of outer surface of outer barrel cam follower;
inner sleeve gear, is a sleeve gear with external teeth, of length equal to the length of inner barrel cam follower, and outer radius equal to the inner radius of the inner barrel cam follower with its rear end coaxially attached to the rear end of outer sleeve gear via a sleeve gear connector a circular annular plate;
longitudinal teeth on the outer surface of inner sleeve gear meshingly engages with longitudinal teeth of inner surface of inner barrel cam follower.

9. Fuel delivery and ignition mechanism, claimed in claim [1], consists of ignition chamber seal, spark plug, ignition coil, air-fuel valve, fuel pipe, fuel injector wherein
ignition chamber seal, a circular disk attached with valve deck, spark plug deck and seal support rod caps the inner annular cylinder of ignition chamber so that nozzle falls close to its rear side;
valve deck, an horizontal annular cylindrical, is sealingly attached at its rear end to a hole at the center of front side of ignition chamber seal and opening on former's rear side towards the nozzle of the ignition chamber;
spark plug deck, a horizontal narrow annular cylindrical which at its rear end houses spark plug such that latter's electrode lies inside ignition chamber facing towards the nozzle and front part leads to ignition coil, is located on right side of and parallel to valve deck;
seal support rod, a L-shaped rod, whose horizontal arm is located on lower side of and parallel to valve deck and is attached at its rear end to the front side of ignition chamber seal and vertical arm is attached to engine enclosure;
air-fuel valve, is housed in valve deck so that it opens inside the ignition chamber towards the nozzle and spring retainer attached with air-fuel valve cam follower, is exposed outside the valve deck and is operated by air-fuel valve cam;
air-fuel valve cam, is a cylindrical cam located on the inner side of the exposed portion of the outer cylinder near to spring retainer of air-fuel valve;
air-fuel pipe, a L-shaped pipe, with its horizontal arm parallel to valve deck bent appropriately, to pass through into valve deck and vertical arm extends downward to lead to fuel injector outside of outer cylinder of ignition chamber;
air-fuel valve cam follower, a pair of small rectangular plates, attached at diametrically opposite ends of spring retainer extending radially towards air-fuel valve cam, wherein each of rectangular plates has a hole through which horizontal arm of spark fuel deck and air-fuel pipe pass through.

10. Flywheel, claimed in claim [1], an externally teethed circular annular gear that functions as an output of the engine, is connected coaxially to the front side extension of outer annular cylinder of ignition chamber.

11. Thrust vectored ignition chamber engine described above is an engine which can use petrol as fuel and in order to use diesel as a fuel we need to replace spark plug with pressure valve, ignition coil with fuel source, air-fuel valve with air valve.

12. According to another variation to above description, thrust vectoring nozzle consists of pair of curved conical tubes so that escape angle of gas at outer surface of outer annular cylinder of ignition chamber can be closer to tangent of circle described by nozzles with aperture of nozzles inside the inner annular cylinder of ignition chamber, is along radial direction.
